(19) United States
(12) Patent Application Publication
(10) Pub. No.: US 2021/0150388 A1
(43) Pub. Date: May 20, 2021

(54) MODEL ESTIMATION SYSTEM, MODEL ESTIMATION METHOD, AND MODEL ESTIMATION PROGRAM

(71) Applicant: NEC CORPORATION, Tokyo (JP)

(72) Inventor: Riki ETO, Tokyo (JP)

(73) Assignee: NEC Corporation, Tokyo (JP)

(21) Appl. No.: 17/043,783

(22) PCT Filed: Mar. 30, 2018
(86) PCT No.: PCT/JP2018/013589

§ 371 Date: Sep. 30, 2020

(51) Int. Cl. G06N 5/04; G06N 20/00; G06Q 30/02; G05D 1/02

(52) U.S. Cl. CPC G06N 5/04; G06N 20/00; G05D 2201/0213; G06Q 30/0206; G05D 1/0221; G06Q 30/0201

(57) ABSTRACT

An input unit 81 inputs action data, in which a state of an environment and an action performed under the environment are associated with each other, a prediction model for predicting a state according to the action on the basis of the action data, and explanatory variables of objective functions for evaluating the state and the action together. A structure setting unit 82 sets a branch structure in which the objective functions are placed at lowermost nodes of a hierarchical mixtures of experts model. A learning unit 83 learns the objective functions including the explanatory variables and branching conditions at nodes of the hierarchical mixtures of experts model, on the basis of the states predicted with the prediction model applied to the action data divided in accordance with the branch structure.

### TECHNICAL FIELD

The present invention relates to a model estimation system, a model estimation method, and a model estimation program for estimating a model that determines an action according to the state of the environment.

### BACKGROUND ART

Mathematical optimization is developing as a field of operations research. Mathematical optimization is used, for example, in the field of retailing to determine optimal prices and in the field of automated driving to determine appropriate routes. A method is also known which uses a prediction model, typified by a simulator, to determine more optimal information.

For example, Patent Literature (PTL) 1 describes an information processing device for efficiently realizing control learning according to the environment of the real world. The information processing device described in PTL 1 classifies environmental parameters, which are the environmental information on the real world, into a plurality of clusters and learns a generated model for each cluster. Further, to reduce the cost, the information processing device described in PTL 1 eliminates various restrictions by realizing the control learning that uses a physical simulator.

### CITATION LIST

### Patent Literature

PTL 1: PCT International Patent Application No. 2017/163538

### SUMMARY OF INVENTION

### Technical Problem

On the other hand, it is also known that it is difficult to set an objective function in mathematical optimization. For example, suppose that a price-based sales prediction model is generated in pricing in retailing. Even if appropriate prices can be set in the short term on the basis of the sales volumes predicted by the prediction model, it will be difficult to determine how to build up sales over the medium term.

Further, suppose that a model is generated in route setting in automated driving that predicts the vehicle motion based on steering and accelerator operations. Even if an appropriate route can be set for a certain section using the prediction model as well as a manually created objective function, it will be difficult to determine what standard (objective function) should be used to set the route over the entire driving section, considering the driving environments that change from time to time and the differences of the subjective views of drivers.

To address such issues, inverse reinforcement learning is known which estimates the goodness of an action taken in response to a certain state, on the basis of an expert's action history and a prediction model. Quantitatively defining the goodness of actions enables imitating the expert-like actions. For example, in the case of automatic driving, an objective function for performing model predictive control can be generated by performing inverse reinforcement learning using drivers driving data. In the inverse reinforcement learning, autonomous driving data can be generated by executing the model predictive control (simulation), allowing an appropriate objective function to be generated so as to cause the autonomous driving data to approach the drivers driving data.

On the other hand, the drivers driving data typically includes driving data of drivers with different characteristics and/or driving data in different driving situations. It is therefore very costly to classify such driving data in accordance with various situations or characteristics and subject the resultant data to learning.

In the information processing device described in PTL 1, good expert information is defined according to various policies, such as a driver who can arrive quickly at a destination, a driver who drives safely, and so on. However, different drivers have different intentions (personalities) of being conservative or aggressive, and the intentions (personalities) may vary depending on the driving situations. Accordingly, it is difficult for a user to arbitrarily define the classification conditions as described in PTL 1, and it is also costly to separate and learn the data for each classification condition (e.g., the user's intention of whether being conservative or aggressive).

In view of the foregoing, it is an object of the present invention to provide a model estimation system, a model estimation method, and a model estimation program capable of efficiently estimating a model in which an objective function to be applied can be selected according to the conditions.

### Solution to Problem

A model estimation system according to the present invention includes: an input unit configured to input action data, in which a state of an environment and an action performed under the environment are associated with each other, a prediction model for predicting a state according to the action on the basis of the action data, and explanatory variables of objective functions for evaluating the state and the action together; a structure setting unit configured to set a branch structure in which the objective functions are placed at lowermost nodes of a hierarchical mixtures of experts model; and a learning unit configured to learn the objective functions including the explanatory variables and branching conditions at nodes of the hierarchical mixtures of experts model, on the basis of the states predicted with the prediction model applied to the action data divided in accordance with the branch structure.

A model estimation method according to the present invention includes: inputting action data, in which a state of an environment and an action performed under the environment are associated with each other, a prediction model for predicting a state according to the action on the basis of the action data, and explanatory variables of objective functions for evaluating the state and the action together; setting a branch structure in which the objective functions are placed at lowermost nodes of a hierarchical mixtures of experts model; and learning the objective functions including the explanatory variables and branching conditions at nodes of the hierarchical mixtures of experts model, on the basis of the states predicted with the prediction model applied to the action data divided in accordance with the branch structure.

A model estimation program according to the present invention causes a computer to perform: input processing of inputting action data, in which a state of an environment and an action performed under the environment are associated with each other, a prediction model for predicting a state according to the action on the basis of the action data, and explanatory variables of objective functions for evaluating the state and the action together; structure setting processing of setting a branch structure in which the objective functions are placed at lowermost nodes of a hierarchical mixtures of experts model; and learning processing of learning the objective functions including the explanatory variables and branching conditions at nodes of the hierarchical mixtures of experts model, on the basis of the states predicted with the prediction model applied to the action data divided in accordance with the branch structure.

### Advantageous Effects of Invention

According to the present invention, a model that can select an objective function to be applied according to the conditions can be estimated efficiently.

### BRIEF DESCRIPTION OF DRAWINGS

FIG. 1 It depicts a block diagram showing an exemplary configuration of an embodiment of a model estimation system according to the present invention.

FIG. 2 It depicts a diagram illustrating examples of a branch structure.

FIG. 3 It depicts a diagram illustrating an example of a model estimation result.

FIG. 4 It depicts a flowchart illustrating an exemplary operation of the model estimation system.

FIG. 5 It depicts a block diagram showing an overview of a model estimation system according to the present invention.

### DESCRIPTION OF EMBODIMENT

An embodiment of the present invention will be described below with reference to the drawings. The model estimated in the present invention is one that has a branch structure in which objective functions are located at the lowermost nodes of a hierarchical mixtures of experts (HME) model. That is, the model estimated in the present invention is a model having a plurality of expert networks connected in a tree-like hierarchical structure. Each branch node is provided with a condition (branching condition) for allocating branches according to inputs.

Specifically, a node called a gating function is assigned to each branch node. The branching probabilities are calculated at each gate for the input data, and the objective function corresponding to the leaf node with the highest probability of reaching is selected.

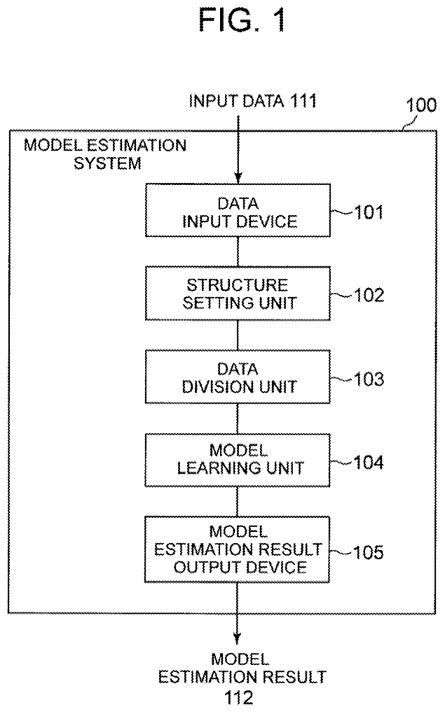

FIG. 1 is a block diagram showing an exemplary configuration of an embodiment of a model estimation system according to the present invention. A model estimation system 100 of the present embodiment includes a data input device 101, a structure setting unit 102, a data division unit 103, a model learning unit 104, and a model estimation result output device 105.

When input data 111 is input, the model estimation system 100 learns, on the input data 111, categorization of data into cases, objective functions in the respective cases, and branching conditions, and outputs the learned branching conditions and objective functions in the respective cases as a model estimation result 112.

The data input device 101 is a device for inputting the input data 111. The data input device 101 inputs various data required for model estimation. Specifically, the data input device 101 inputs, as the input data 111, data (hereinafter, referred to as action data) in which a state of an environment and an action performed under the environment are associated with each other.

In the present embodiment, the inverse reinforcement learning is performed by using history data of decisions made by an expert under certain environments as the action data. The use of such action data enables model predictive control of imitating the expert's actions. Further, the objective function can be read as a reward function to allow for reinforcement learning. In the following, the action data may also be referred to as expert decision-making history data. Various states can be assumed as the states of the environment. For example, the states of the environment related to automated driving include the driver's own conditions, current driving speed and acceleration, traffic conditions, and weather conditions. The states of the environment related to retailing include weather, the presence or absence of an event, and whether it is a weekend or not.

Examples of the action data related to automated driving include a good driver's driving history (e.g., acceleration, braking timing, travel lane, lane change status, etc.). Further, examples of the action data related to retailing include a store manager's order history and pricing history. It should be noted that the contents of the action data are not limited to those described above. Any information representing the actions to be imitated is available as the action data.

Further, illustrated here is the case where the expert's decision making is used as the action data. The subject of the action data, however, is not necessarily limited to experts. History data of decisions made by any subject the user wishes to imitate may be used as the action data.

The data input device 101 also inputs, as the input data 111, a prediction model for predicting a state according to the action on the basis of the action data. The prediction model may, for example, be represented by a prediction formula indicating the states that change according to the actions. Examples of the prediction model related to automated driving include a vehicle motion model. Examples of the prediction model related to retailing include a sales prediction model based on set prices and order volumes.

The data input device 101 also inputs explanatory variables used for objective functions that evaluate the state and the action together. The contents of the explanatory variables are also optional. Specifically, the contents included in the action data may be used as the explanatory variables. Examples of the explanatory variables related to retailing include calendar information, distances from stations, weather, price information, and number of orders. Examples of the explanatory variables related to automated driving include speed, positional information, and acceleration. In addition, as the explanatory variables related to automated driving, the distance from the centerline, steering phase, the distance from the vehicle in front, etc. may be used.

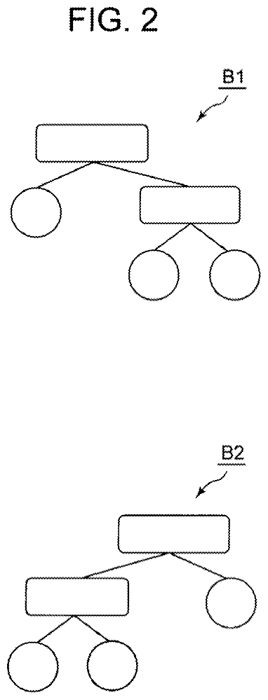

The data input device 101 also inputs a branch structure of the HME model. Here, the HME model assumes a tree-like hierarchical structure, so the branch structure is represented by a structure combining branch nodes and leaf nodes. FIG. 2 is a diagram illustrating examples of the branch structure. In the branch structures illustrated in FIG. 2, each round square represents a branch node and each circle represents a leaf node. The branch structure B1 and branch structure B2 illustrated in FIG. 2 are both structured to have three leaf nodes. These two branch structures, however, are interpreted as different structures. The number of leaf nodes can be specified from the branch structure, so the number of objective functions to be classified is specified.

The structure setting unit 102 sets the input branch structure of the HME model. The structure setting unit 102 may store the input branch structure of the HME model in an internal memory (not shown).

The data division unit 103 divides the action data on the basis of the set branch structure. Specifically, the data division unit 103 divides the action data in correspondence with the lowermost nodes of the HME model. That is, the data division unit 103 divides the action data according to the number of leaf nodes in the set branch structure. It should be noted that the way of dividing the action data is not limited. The data division unit 103 may, for example, randomly divide the input action data.

The model learning unit 104 applies the prediction model to the divided action data to predict the state. The model learning unit 104 then learns the branching conditions at the branch nodes and the objective functions in the respective leaf nodes of the HME model, for each divided action data. Specifically, the model learning unit 104 learns the branching conditions and the objective functions by the expectation-maximization (EM) algorithm and the inverse reinforcement learning. The model learning unit 104 may learn the objective functions by, for example, maximum entropy inverse reinforcement learning, Bayesian inverse reinforcement learning, or maximum likelihood inverse reinforcement learning. The branching conditions may include a condition using the input explanatory variable.

The model learned by the model learning unit 104 can be said to be a hierarchical objective function model because the objective functions are arranged at the hierarchically branched leaf nodes. For example, in the case where the data input device 101 has input a store's order history or pricing history as the action data, the model learning unit 104 may learn objective functions used for optimization of prices. Further, for example in the case where the data input device 101 has input a driver's driving history as the action data, the model learning unit 104 may learn objective functions used for optimization of vehicle driving.

When it is determined that the model learning by the model learning unit 104 is complete (sufficient), the model estimation result output device 105 outputs the learned branching conditions and objective functions in the respective cases as the model estimation result 112. On the other hand, if it is determined that the model learning is incomplete (insufficient), the process is transferred to the data division unit 103, and the processing described above is performed in the same way.

Specifically, the model estimation result output device 105 evaluates the degree of deviation indicating how far the result obtained by applying the action data to the hierarchical objective function model, having its branching conditions and objective variables learned, deviates from that action data. The model estimation result output device 105 may use a least squares method, for example, as the method for calculating the degree of deviation. If the deviation meets a predetermined criterion (e.g., the deviation is not greater than a threshold value), the model estimation result output device 105 may determine that the model learning is complete (sufficient). On the other hand, if the deviation does not meet the predetermined criterion (e.g., the deviation is greater than the threshold value), the model estimation result output device 105 may determine that the model learning is incomplete (insufficient). In this case, the data division unit 103 and the model learning unit 104 repeat the processing until the degree of deviation meets the predetermined criterion.

It should be noted that the model learning unit 104 may perform the processing of the data division unit 103 and the model estimation result output device 105.

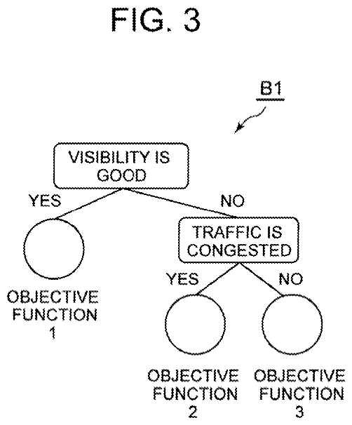

FIG. 3 is a diagram illustrating an example of the model estimation result 112. FIG. 3 illustrates, by way of example, a model estimation result obtained when the branch structure illustrated in FIG. 2 is provided. The example shown in FIG. 2 indicates that the uppermost node is provided with a branching condition determining whether or not “visibility is good”, and an objective function 1 is applied when it is judged as “Yes”. It also indicates that, when it is judged as “No” in the branching condition determining whether or not “visibility is good”, a further branching condition determining whether or not “the traffic is congested” is provided, and an objective function 2 is applied when it is judged as “Yes” and an objective function 3 when judged as “No”.

In the present embodiment, for example in the case of automated driving described above, various driving data can be provided collectively, so that the objective functions can be learned for each situation (overtaking, merging, etc.) and for each driver characteristic. That is, it is possible to generate an objective function for aggressive overtaking, an objective function for conservative merging, an objective function for energy-saving merging, and so on, as well as a logic for switching between the objective functions. That is, by switching between a plurality of objective functions, appropriate actions can be selected under various conditions. Specifically, the contents of respective objective functions are determined according to the branching conditions and the characteristics indicated by the generated objective functions.

The data input device 101, the structure setting unit 102, the data division unit 103, the model learning unit 104, and the model estimation result output device 105 are implemented by a CPU of a computer that operates in accordance with a program (the model estimation program). For example, the program may be stored in a storage unit (not shown) provided in the model estimation system, and the CPU may read the program and operate as the data input device 101, the structure setting unit 102, the data division unit 103, the model learning unit 104, and the model estimation result output device 105 in accordance with the program. The functions of the present model estimation system may also be provided in the form of Software as a Service (SaaS).

Further, the data input device 101, the structure setting unit 102, the data division unit 103, the model learning unit 104, and the model estimation result output device 105 may each be implemented by dedicated hardware. The data input device 101, the structural setting unit 102, the data division unit 103, the model learning unit 104, and the model estimation result output device 105 may each be implemented by general-purpose or dedicated circuitry. Here, the general-purpose or dedicated circuitry may be configured by a single chip or by a plurality of chips connected via a bus. Further, when some or all of the components of each device are realized by a plurality of information processing devices or circuits, the information processing devices or circuits may be disposed in a centralized or distributed manner. For example, the information processing devices or circuits may be implemented in the form of a client server system, a cloud computing system, or the like, where the devices or circuits are connected via a communication network.

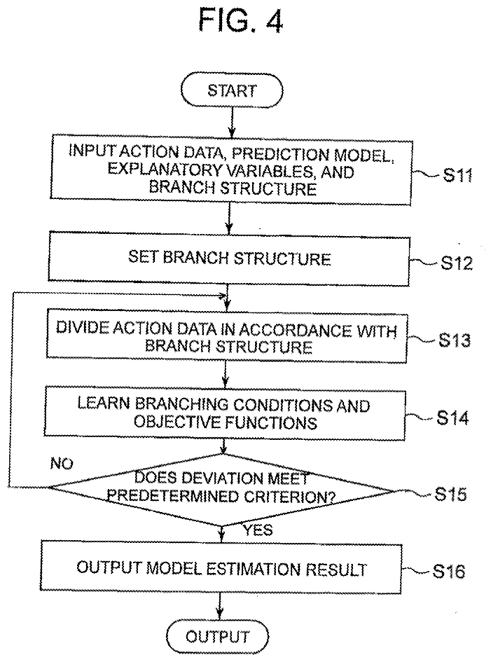

An operation of the model estimation system of the present embodiment will now be described. FIG. 4 is a flowchart illustrating an exemplary operation of the model estimation system of the present embodiment.

Firstly, the data input device 101 inputs action data, a prediction model, explanatory variables, and a branch structure (step S11). The structure setting unit 102 sets the branch structure (step S12). The branch structure is a structure in which objective functions are placed at lowermost nodes of the HME model. The data division unit 103 divides the action data in accordance with the branch structure (step S13). The model learning unit 104 learns branching conditions at the nodes of the HME model and the objective functions, on the basis of the states predicted with the prediction model applied to the divided action data (step S14).

The model estimation result output device 105 determines whether the deviation between the results of applying the action data to the model and that action data meets a predetermined criterion (step S15). If the deviation meets the predetermined criterion (Yes in step S15), the model estimation result output device 105 outputs the learned branching conditions and the objective functions in the respective cases as the model estimation result 112 (step S16). On the other hand, if the deviation does not meet the predetermined criterion (No in step S15), the processing in step S13 and on is repeated.

As described above, in the present embodiment, the data input device 101 inputs action data, a prediction model, and explanatory variables, and the structure setting unit 102 sets a branch structure in which objective functions are placed at lowermost nodes of the HME model. The model learning unit 104 then learns the objective functions and branching conditions at the nodes of the HME, on the basis of the states predicted with the prediction model applied to the action data divided in accordance with the branch structure.

Such a configuration allows the objective functions to be learned for each characteristic, even if the action data is given collectively. In addition, in the present embodiment, a prediction model such as a simulator is used in combination with the common HME model learning. This allows hierarchical branching conditions as well as appropriate objective functions to be learned from the action data. It is therefore possible to estimate a model that can select an objective function to be applied according to the conditions.

Further, in the present embodiment, the branching conditions include a condition that uses the explanatory variable of the objective function and a condition that uses an explanatory variable solely for the branching condition. This makes it easier for a user to interpret the objective functions selected according to the conditions. In the case of automated driving, suppose that a branching condition indicates whether or not “it is rainy”. In this case, it is readily possible to make a comparison between the explanatory variables in the objective function selected in the case of “Yes” and in the objective function selected in the case of “No”. In such a case, it is conceivable, for example, that the coefficient of the “degree of change of steering” will be smaller in rainy conditions than in sunny conditions. Such information may also be readily determined from the model estimation result.

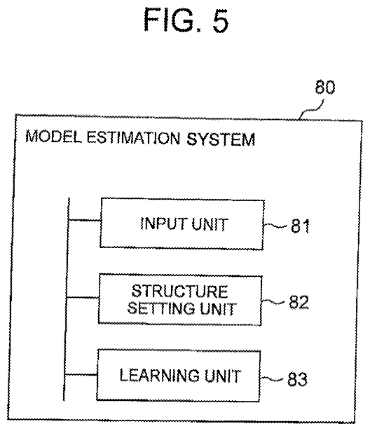

An overview of the present invention will now be described. FIG. 5 is a block diagram showing an overview of a model estimation system according to the present invention. A model estimation system 80 (e.g., the model estimation system 100) according to the present invention includes: an input unit 81 (e.g., the data input device 101) that inputs action data (e.g., driving history, order history, etc.) in which a state of an environment and an action performed under the environment are associated with each other, a prediction model (e.g., a simulator, etc.) for predicting a state according to the action on the basis of the action data, and explanatory variables of objective functions for evaluating the state and the action together; a structure setting unit 82 (e.g., the structure setting unit 102) that sets a branch structure in which the objective functions are placed at lowermost nodes of a hierarchical mixtures of experts model (i.e. the HME model); and a learning unit 83 (e.g., the model learning unit 104) that learns the objective functions including the explanatory variables and branching conditions at nodes of the hierarchical mixtures of experts model, on the basis of the states predicted with the prediction model applied to the action data divided in accordance with the branch structure.

Such a configuration enables efficient estimation of a model that can select an objective function to be applied according to the conditions.

The learning unit 83 may learn the branching conditions and the objective functions by an EM algorithm and inverse reinforcement learning.

Specifically, the learning unit 83 may learn the objective functions by maximum entropy inverse reinforcement learning, Bayesian inverse reinforcement learning, or maximum likelihood inverse reinforcement learning.

Further, the learning unit 83 may evaluate the degree of deviation of a result obtained by applying the action data to the hierarchical mixtures of experts model, with its branching conditions and objective variables learned, from that action data, and repeat the learning until the degree of deviation becomes not greater than a predetermined threshold value (e.g., the degree of deviation is within the predetermined threshold value).

Further, the learning unit 83 may divide the action data in correspondence with the lowermost nodes of the hierarchical mixtures of experts model, and use the prediction model and the divided action data to learn the objective functions and the branching conditions for each of the divided action data.

Further, the branching conditions may include a condition using the explanatory variable.

Further, the input unit 81 may input a store's order history or pricing history as the action data, and the learning unit 83 may learn objective functions used for optimization of prices.

Alternatively, the input unit 81 may input a driver's driving history as the action data, and the learning unit 83 may learn objective functions used for optimization of vehicle driving.

### REFERENCE SIGNS LIST

100 model estimation system
101 data input device
102 structure setting unit
103 data division unit
104 model learning unit
105 model estimation result output device

1. A model estimation system comprising a hardware processor configured to execute a software code to:
input action data, in which a state of an environment and an action performed under the environment are associated with each other, a prediction model for predicting a state according to the action on the basis of the action data, and explanatory variables of objective functions for evaluating the state and the action together;
set a branch structure in which the objective functions are placed at lowermost nodes of a hierarchical mixtures of experts model; and
learn the objective functions including the explanatory variables and branching conditions at nodes of the hierarchical mixtures of experts model, on the basis of the states predicted with the prediction model applied to the action data divided in accordance with the branch structure.

2. The model estimation system according to claim 1, wherein the hardware processor is configured to execute a software code to learn the branching conditions and the objective functions by an EM (expectation-maximization) algorithm and inverse reinforcement learning.

3. The model estimation system according to claim 1, wherein the hardware processor is configured to execute a software code to learn the objective functions by maximum entropy inverse reinforcement learning, Bayesian inverse reinforcement learning, or maximum likelihood inverse reinforcement learning.

4. The model estimation system according to claim 1, wherein the hardware processor is configured to execute a software code to evaluate the degree of deviation of a result obtained by applying the action data to the hierarchical mixtures of experts model, with its branching conditions and objective functions learned, from said action data, and repeat the learning until the degree of deviation becomes not greater than a predetermined threshold value.

5. The model estimation system according to claim 1, wherein the hardware processor is configured to execute a software code to divide the action data in correspondence with the lowermost nodes of the hierarchical mixtures of experts model, and use the prediction model and the divided action data to learn the objective functions and the branching conditions for each of the divided action data.

6. The model estimation system according to claim 1, wherein the branching conditions include a condition using the explanatory variable.

7. The model estimation system according to claim 1, wherein the hardware processor is configured to execute a software code to:
input a store's order history or pricing history as the action data; and
learn objective functions used for optimization of prices.

8. The model estimation system according to claim 1, wherein the hardware processor is configured to execute a software code to:
input a driver's driving history as the action data, and
learn objective functions used for optimization of vehicle driving.

9. A model estimation method comprising:
inputting action data, in which a state of an environment and an action performed under the environment are associated with each other, a prediction model for predicting a state according to the action on the basis of the action data, and explanatory variables of objective functions for evaluating the state and the action together;
setting a branch structure in which the objective functions are placed at lowermost nodes of a hierarchical mixtures of experts model; and
learning the objective functions including the explanatory variables and branching conditions at nodes of the hierarchical mixtures of experts model, on the basis of the states predicted with the prediction model applied to the action data divided in accordance with the branch structure.

10. A non-transitory computer readable information recording medium storing a model estimation program, when executed by a processor, that performs a method for:
inputting action data, in which a state of an environment and an action performed under the environment are associated with each other, a prediction model for predicting a state according to the action on the basis of the action data, and explanatory variables of objective functions for evaluating the state and the action together;
setting a branch structure in which the objective functions are placed at lowermost nodes of a hierarchical mixtures of experts model; and
learning the objective functions including the explanatory variables and branching conditions at nodes of the hierarchical mixtures of experts model, on the basis of the states predicted with the prediction model applied to the action data divided in accordance with the branch structure.
